(19) United States
(12) Patent Application Publication
(10) Pub. No.: US 2026/0283244 A1
(43) Pub. Date: Sep. 24, 2026

(54) AEROSOL GENERATING DEVICE, AND HEATER AND CONTROL METHOD FOR AEROSOL GENERATING DEVICE

(71) Applicant: SHENZHEN FIRST UNION TECHNOLOGY CO., LTD., Shenzhen, Guangdong (CN)

(72) Inventors: Wei CHEN, Shenzhen, Guangdong (CN); Ruilong HU, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 19/474,426

(22) PCT Filed: Mar. 28, 2024
(86) PCT No.: PCT/CN2024/084326

§ 371 Date: Oct. 10, 2025

(30) Foreign Application Priority Data
Apr. 11, 2023 (CN) 202310400707.0

(51) Int. Cl. A24F 40/46; A24F 40/20; A24F 40/57; H01M 10/615; H01M 10/623; H01M 10/63; H01M 10/654; H01M 50/247; H05B 3/00

(52) U.S. Cl. CPC A24F 40/46; A24F 40/20; A24F 40/57; H01M 10/615; H01M 10/623; H01M 10/63; H01M 10/654; H01M 50/247; H05B 3/0014; H01M 2220/30; H05B 2203/005; H05B 2203/016

(57) ABSTRACT

An aerosol generating device, and a heater and a control method for an aerosol generating device. The aerosol generating device includes: a chamber, configured to accommodate an aerosol generating article; a first heating element and a second heating element, arranged along a longitudinal direction of the chamber to heat the aerosol generating article; and a battery core, configured to provide power. The aerosol generating device is configured to selectively electrically connect one of the first heating element and the second heating element to the battery core to perform heating separately, and selectively electrically connect the first heating element and the second heating element to the battery core in series or in parallel to simultaneously perform heating.

### CROSS-REFERENCE TO RELATED APPLICATIONS

This application claims priority to Chinese Patent Application 202310400707.0, filed with the China National Intellectual Property Administration on Apr. 11, 2023 and entitled “AEROSOL GENERATING DEVICE, AND HEATER AND CONTROL METHOD FOR AEROSOL GENERATING DEVICE”, which is incorporated herein by reference in its entirety.

### TECHNICAL FIELD

Embodiments of this application relate to the field of aerosol generating technologies, and in particular, to an aerosol generating device, and a heater and a control method for an aerosol generating device.

### BACKGROUND

During use of tobacco products (for example, cigarettes and cigars), tobaccos are burnt to generate tobacco vapor. Attempts are made to replace these tobacco-burning products by manufacturing products that release compounds without burning tobacco.

An example of such products is a heating device, which releases compounds by heating rather than burning materials. For example, the material may be an aerosol generating article including tobacco or other non-tobacco products. These non-tobacco products may or may not include nicotine. To heat the aerosol generating article to a temperature allowing to release volatile components that can form an aerosol, a conventional heating device generally heats the aerosol generating article through a tubular infrared emitter surrounding the aerosol generating article and radiating infrared rays to produce the aerosol. The tubular infrared emitter typically includes a tubular infrared-transmitting base such as a quartz tube, and an infrared-emitting coating deposited outside the base.

### SUMMARY

An embodiment of this application provides an aerosol generating device, configured to heat an aerosol generating article to generate an aerosol, and including:
a chamber, configured to accommodate the aerosol generating article;
a first heating element and a second heating element, arranged along a longitudinal direction of the chamber and configured to heat the aerosol generating article; and
a battery core, configured to provide power to the first heating element and the second heating element, where
the aerosol generating device is configured to selectively electrically connect one of the first heating element and the second heating element to the battery core to separately perform heating, and selectively electrically connect the first heating element and the second heating element to the battery core in series or in parallel to simultaneously perform heating.

In some embodiments, the device includes:
an opening, where in use, the aerosol generating article is at least partially accommodated in the chamber or removed from the chamber through the opening; and
the first heating element is closer to the opening than the second heating element.

In some embodiments, the device includes:
a base, at least partially surrounding or defining the chamber, where the first heating element includes a coating or a thin film or a heating mesh coupled to the base;
and/or the second heating element includes a coating or a thin film or a heating mesh coupled to the base.

In some embodiments, the first heating element includes at least one of an infrared heating element or a resistive heating element;
and/or the second heating element includes at least one of the infrared heating element or the resistive heating element.

In some embodiments, when the first heating element and the second heating element are electrically connected to the battery core in series to simultaneously perform heating, an operating power of the first heating element is less than an operating power of the second heating element.

In some embodiments, when the first heating element and the second heating element are electrically connected to the battery core in parallel to simultaneously perform heating, a power of the first heating element is greater than a power of the second heating element.

In some embodiments, the aerosol generating device is configured to:
electrically connect the first heating element to the battery core separately during a first time period, so that the first heating element separately performs heating; and
electrically connect the first heating element and the second heating element in series to the battery core during a second time period, so that the first heating element and the second heating element simultaneously perform heating.

In some embodiments, the aerosol generating device is configured to:
electrically connect the first heating element to the battery core separately during a first time period, so that the first heating element separately performs heating; and
electrically connect the first heating element and the second heating element in parallel to the battery core during a second time period, so that the first heating element and the second heating element simultaneously perform heating.

In some embodiments, the aerosol generating device is configured to control power provided by the battery core to the first heating element and the second heating element, so that a temperature of the first heating element is higher than a temperature of the second heating element by a first temperature difference during a first time period, and the temperature of the first heating element is higher than the temperature of the second heating element by a second temperature difference during a second time period; and
the first temperature difference is greater than the second temperature difference.

In some embodiments, the device further includes:
a first electrode, a second electrode, and a third electrode, selectively electrically connected to the battery core, where
the first heating element is at least partially electrically connected between the first electrode and the second electrode; and the second heating element is at least partially electrically connected between the first electrode and the third electrode.

In some embodiments, the aerosol generating device is arranged to electrically connect one or two of the first heating element and second heating element to the battery core by selectively electrically connecting two or three of the first electrode, the second electrode, and the third electrode to the battery core.

In some embodiments, the first electrode is arranged to extend at least partially from the first heating element to the second heating element and to be electrically conductive with the first heating element and the second heating element;
the second electrode is arranged on the first heating element and avoids the second heating element, and is electrically conductive with the first heating element; and
the third electrode is arranged on the second heating element and avoids the first heating element, and is electrically conductive with the second heating element.

In some embodiments, the device further includes:
one or more fourth electrodes, arranged on the first heating element at intervals along a circumferential direction to reduce a resistance value of the first heating element, where the fourth electrodes are not electrically connected to the battery core.

In some embodiments, the device further includes one or more fourth electrodes arranged on the first heating element at intervals along a circumferential direction to separate the first heating element to define at least two heating areas connected in series between the first electrode and the second electrode.

In some embodiments, a width of the fourth electrode along a circumferential direction of the chamber is less than a width of the first electrode and/or the second electrode and/or the third electrode along the circumferential direction of the chamber.

In some embodiments, the width of the fourth electrode along the circumferential direction of the chamber is in a range of 0.5-3 mm.

In some embodiments, the width of the first electrode and/or the second electrode and/or the third electrode along the circumferential direction of the chamber is in a range of 2-5 mm.

In some embodiments, the device further includes:
one or more fifth electrodes, arranged on the second heating element at intervals along the circumferential direction to reduce a resistance value of the second heating element, where the fifth electrodes are not electrically connected to the battery core.

In some embodiments, a quantity of the fifth electrodes is different from a quantity of the fourth electrodes;
and/or a width of the fourth electrode along the circumferential direction of the chamber is different from a width of the fifth electrode along the circumferential direction of the chamber.

In some embodiments, the device further includes:
one or more fifth electrodes, arranged on the second heating element at intervals along a circumferential direction to separate the second heating element into at least two heating areas connected in series between the first electrode and the third electrode.

In some embodiments, the second electrode and the third electrode are aligned along the longitudinal direction of the chamber.

In some embodiments, the first electrode and the second electrode are arranged opposite to each other along a radial direction of the chamber;
and/or the first electrode and the third electrode are arranged opposite to each other along the radial direction of the chamber.

In some embodiments, the aerosol generating device includes only two heating elements.

In some embodiments, the device further includes:
a first temperature sensor, configured to sense a temperature of the first heating element;
and/or a second temperature sensor, configured to sense a temperature of the second heating element.

In some embodiments, the aerosol generating device is configured to:
electrically connect the first heating element and the second heating element in parallel to the battery core during a first time period, so that the first heating element and the second heating element simultaneously perform heating; and
electrically connect the first heating element and the second heating element in series to the battery core during a second time period, so that the first heating element and the second heating element simultaneously perform heating.

Another embodiment of this application further provides an aerosol generating device, configured to heat an aerosol generating article to generate an aerosol, the device including:
a chamber, configured to accommodate the aerosol generating article;
a first heating element and a second heating element, arranged along a longitudinal direction of the chamber and configured to heat the aerosol generating article;
a battery core, configured to provide power to the first heating element and the second heating element; and
a circuit, configured to control the battery core to separately provide the power to the first heating element during a first time period, so that the first heating element separately performs heating; and control the battery core to simultaneously provide the power to the first heating element and the second heating element during a second time period, so that the first heating element and the second heating element simultaneously perform heating.

In some embodiments, during the second time period, the first heating element and the second heating element are connected in series.

In some embodiments, during the second time period, an operating power of the first heating element is less than an operating power of the second heating element.

Another embodiment of this application further provides an aerosol generating device, configured to heat an aerosol generating article to generate an aerosol, the device including:
a chamber, configured to accommodate the aerosol generating article;
a first heating element and a second heating element, arranged along a longitudinal direction of the chamber and configured to heat the aerosol generating article;
a battery core, configured to provide power to the first heating element and the second heating element; and
a circuit, configured to control the power provided by the battery core to the first heating element and the second heating element, so that a temperature of the first heating element is higher than a temperature of the second heating element by a first temperature difference during a first time period, and the temperature of the first heating element is higher than the temperature of the second heating element by a second temperature difference during a second time period, where
the first temperature difference is greater than the second temperature difference.

Another embodiment of this application further provides an aerosol generating device, configured to heat an aerosol generating article to generate an aerosol, the device including:
a chamber, configured to accommodate the aerosol generating article;
a first heating element and a second heating element, arranged along a longitudinal direction of the chamber and configured to heat the aerosol generating article;
a battery core, configured to provide power to the first heating element and the second heating element; and
a first electrode, a second electrode, and a third electrode, selectively electrically connected to the battery core, where the first heating element is at least partially electrically connected between the first electrode and the second electrode; and the second heating element is at least partially electrically connected between the first electrode and the third electrode.

In some embodiments, the device further includes:
one or more fourth electrodes, arranged on the first heating element at intervals along a circumferential direction to separate the first heating element to define at least two heating areas connected in series between the first electrode and the second electrode, where the fourth electrodes are not electrically connected to the battery core.

In some embodiments, the device further includes:
one or more fifth electrodes, arranged on the second heating element at intervals along a circumferential direction to separate the second heating element to define at least two heating areas connected in series between the first electrode and the third electrode, where the fifth electrodes are not electrically connected to the battery core.

In some embodiments, a quantity of the fifth electrodes is different from a quantity of the fourth electrodes;
and/or a width of the fourth electrode along the circumferential direction of the chamber is different from a width of the fifth electrode along the circumferential direction of the chamber.

Another embodiment of this application further provides a heater for an aerosol generating device, including:
a first heating element and a second heating element arranged in sequence along a longitudinal direction; and
a first electrode, a second electrode, and a third electrode, where
the first heating element is at least partially electrically connected between the first electrode and the second electrode, so as to supply power to the first heating element through the first electrode and the second electrode; and the second heating element is at least partially electrically connected between the first electrode and the third electrode, so as to supply power to the second heating element through the first electrode and the third electrode.

In some embodiments, the device further includes:
one or more fourth electrodes, arranged on the first heating element at intervals along a circumferential direction to separate the first heating element to define at least two heating areas connected in series between the first electrode and the second electrode, where the fourth electrode is not configured to supply power to the first heating element.

In some embodiments, the device further includes:
one or more fifth electrodes, arranged on the second heating element at intervals along the circumferential direction to separate the second heating element into at least two heating areas connected in series between the first electrode and the third electrode, where the fifth electrode is not configured to supply power to the second heating element.

Another embodiment of this application further provides a control method for an aerosol generating device, the aerosol generating device including:
a chamber, configured to accommodate an aerosol generating article;
a first heating element and a second heating element, arranged along a longitudinal direction of the chamber and configured to heat the aerosol generating article; and
a battery core, configured to provide power to the first heating element and the second heating element; and
the method including:
controlling the battery core to separately provide the power to the first heating element during a first time period, so that the first heating element separately performs heating; and control the battery core to simultaneously provide the power to the first heating element and the second heating element during a second time period, so that the first heating element and the second heating element simultaneously perform heating.

Another embodiment of this application further provides a control method for an aerosol generating device, the aerosol generating device including:
a chamber, configured to accommodate an aerosol generating article;
a first heating element and a second heating element, arranged along a longitudinal direction of the chamber and configured to heat the aerosol generating article; and
a battery core, configured to provide power to the first heating element and the second heating element; and
the method including:
electrically connect the first heating element and the second heating element in parallel to the battery core during a first time period, so that the first heating element and the second heating element simultaneously perform heating; and
electrically connect the first heating element and the second heating element in series to the battery core during a second time period, so that the first heating element and the second heating element simultaneously perform heating.

Another embodiment of this application further provides a control method for an aerosol generating device, the aerosol generating device including:
a chamber, configured to accommodate an aerosol generating article;
a first heating element and a second heating element, arranged along a longitudinal direction of the chamber and configured to heat the aerosol generating article; and
a battery core, configured to provide power to the first heating element and the second heating element; and
the method including:
controlling the power provided by the battery core to the first heating element and the second heating element, so that a temperature of the first heating element is higher than a temperature of the second heating element by a first temperature difference during a first time period, and the temperature of the first heating element is higher than the temperature of the second heating element by a second temperature difference during a second time period, where
the first temperature difference is greater than the second temperature difference.

The foregoing aerosol generating device can change a manner in which the first heating element and the second heating element are connected to the battery core separately or simultaneously, which facilitates flexible selection of heating the aerosol generating article separately or differentially simultaneously.

### BRIEF DESCRIPTION OF THE DRAWINGS

One or more embodiments are illustratively described with reference to the figures in the corresponding accompanying drawings, and these illustrative descriptions are not to limit the embodiments. Elements having same reference numerals in the accompanying drawings are denoted as similar elements, and the figures in the accompanying drawings are not drawn to scale, unless particularly stated otherwise.

FIG. 1 is a schematic diagram of an aerosol generating device according to an embodiment.

FIG. 2 is a schematic structural diagram of a heater according to an embodiment from a perspective.

FIG. 3 is a schematic structural diagram of the heater in FIG. 2 from another perspective.

FIG. 4 is a schematic exploded view of the heater in FIG. 2 from a perspective.

FIG. 5 is a schematic unfolded diagram of directing a current on a heater in a circumferential direction according to an embodiment.

FIG. 6 is a schematic unfolded diagram of directing a current on a heater in a circumferential direction according to another embodiment.

FIG. 7 is a schematic unfolded diagram of directing a current on a heater in a circumferential direction according to another embodiment.

FIG. 8 is a schematic structural diagram of a heater according to another embodiment from a perspective.

FIG. 9 is a schematic structural diagram of the heater in FIG. 8 from another perspective.

FIG. 10 is a heating curve of an aerosol generating article through a heater according to an embodiment.

### DETAILED DESCRIPTION

For ease of understanding of this application, this application is described below in more detail with reference to accompanying drawings and specific implementations.

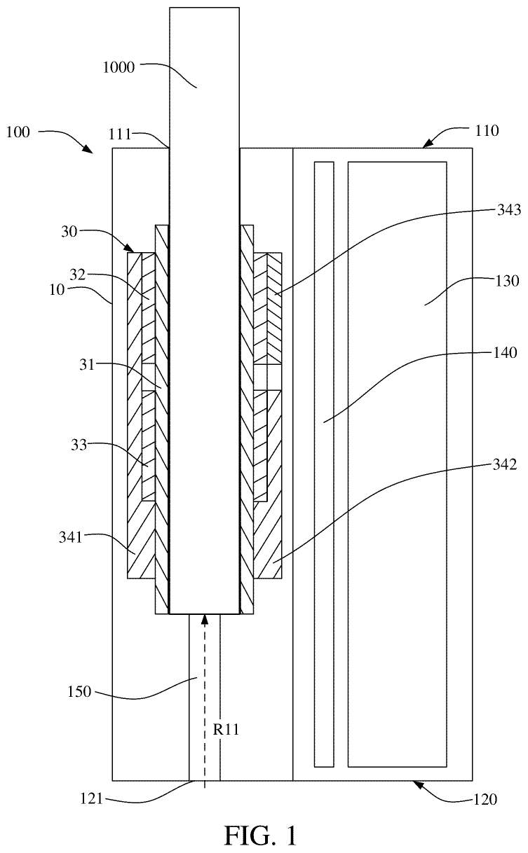

An embodiment of this application provides an aerosol generating device 100 for heating instead of burning an aerosol generating article 1000, such as cigarettes, to evaporate or release at least one component of the aerosol generating article 1000 to form an aerosol for inhalation, as shown in FIG. 1.

Further, in an optional implementation, the aerosol generating article 1000 is preferably made of a tobacco-containing material that releases a volatile compound from a substrate when being heated, or may be a non-tobacco material adapted for electric heating and generating smoke after being heated. The aerosol generating article 1000 is preferably made of a solid substrate. The solid substrate may include one or more of powders, particles, fragment strips, stripes, or flakes of one or more of vanilla leaves, tobacco leaves, homogeneous tobacco, and expanded tobacco. Alternatively, the solid substrate may include additional tobacco or non-tobacco volatile aroma compounds to be released when the substrate is heated.

As shown in FIG. 1, after the aerosol generating article 1000 is accommodated by the aerosol generating device 100, part of the aerosol generating article, such as a filter tip, is exposed outside the aerosol generating device 100, which is beneficial for smoking by a user.

A structure of an aerosol generating device in an embodiment of this application may be shown in FIG. 1. An overall appearance of the device is generally configured in a shape of a flat cylinder. An external component of the aerosol generating device 100 includes:

a housing 10, having an interior that is of a hollow structure, thereby forming an assembly space for necessary functional components such as an electronic device and a heating device. The housing 10 has a proximal end 110 and a distal end 120 opposite to each other along a length direction.

The proximal end 110 is provided with an opening 111. The aerosol generating article 1000 may be accommodated in the housing 10 through the opening 111 to be heated or may be removed from the housing 10.

The distal end 120 is provided with an air inlet hole 121. The air inlet hole 121 is configured to supply external air into the housing 10 during inhalation.

Further, as shown in FIG. 1, the aerosol generating device 100 further includes:
a chamber, configured to accommodate or receive the aerosol generating article 1000, where in use, the aerosol generating article 1000 may be removably accommodated in the chamber through the opening 111. In some embodiments, a length of the aerosol generating article 1000 that is surrounded and heated by a heater 30 is greater than 30 mm.

As shown in FIG. 1, the aerosol generating device 100 further includes:
an air channel 150, located between the chamber and an air inlet 121, where in use, the air channel 150 provides a channel path from the air inlet 121 into the chamber/aerosol generating article 1000, as shown by an arrow R11 in FIG. 1.

Further, as shown in FIG. 1, the aerosol generating device 100 further includes:
a battery core 130, configured to provide electricity, where the battery core 130 is preferably a rechargeable direct-current battery core 130 and may be charged through connection to an external power supply; and
a circuit board 140, such as a printed circuit board (PCB), provided with a circuit or a microcontroller unit (MCU) controller, where the circuit may be an integrated circuit.

Further, as shown in FIG. 1, the aerosol generating device 100 further includes:
a heater 30, at least partially surrounding and defining the chamber, where when the aerosol generating article 1000 is accommodated in the housing 10, the heater 30 at least partially surrounds or encloses the aerosol generating article 1000 and performs heating from a periphery of the aerosol generating article 1000. When accommodated in the housing 10, the aerosol generating article 1000 is at least partially accommodated and held in the heater 30.

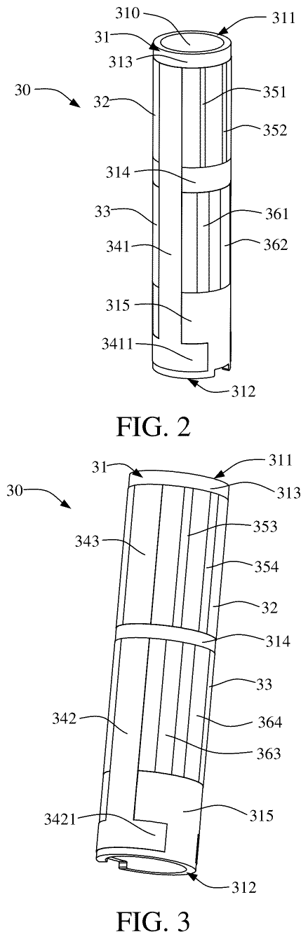

Further, according to embodiments shown in FIG. 2 and FIG. 3, the heater 30 is configured in a substantially longitudinal tubular shape and includes:
a tubular base 31, where in use, an inner hollow 310 of the base 31 is at least partially defined for accommodating and retaining the aerosol generating article 1000;
a first heating element 32 and a second heating element 33, arranged on the base 31, where in this embodiment, the first heating element 32 and/or the second heating element 33 are formed on an outer surface of the base 31 through depositing, spraying, wrapping, or the like. Alternatively, in still some embodiments, the first heating element 32 and/or the second heating element 33 are formed on an inner surface of the base 31.

In some embodiments, the first heating element 32 and/or the second heating element 33 are infrared-emitting layers, for example, electrically driven infrared-emitting layers. By directly providing a direct current voltage to the first heating element 32 and/or the second heating element 33, the first heating element 32 and/or the second heating element 33 may radiate infrared rays through voltage driving, so as to heat the aerosol generating article 1000.

In some embodiments, the first heating element 32 and/or the second heating element 33 for radiating infrared rays may be a coating made of ceramic materials such as zirconium, or Fe—Mn—Cu, tungsten, or transition metals and oxides thereof. For another example, in some embodiments, the first heating element 32 and/or the second heating element 33 for radiating the infrared rays are composed of oxides of at least one metal element such as Mg, Al, Ti, Zr, Mn, Fe, Co, Ni, Cu, Cr, Zn, and the like. These metal oxides can radiate far infrared rays with a heating effect when heated to an appropriate temperature.

In some embodiments, the first heating element 32 and the second heating element 33 are made of a same material, so that the first heating element and the second heating element have a same infrared radiation wavelength or infrared radiation efficiency when different sections of the aerosol generating article 1000 are heated. Alternatively, in still some variant embodiments, the first heating element 32 and the second heating element 33 are made of different materials. The first heating element 32 and the second heating element 33 use different infrared emission spectra, for example, have different WLP (a peak wavelength that is a wavelength corresponding to a maximum radiation power), which may respectively be adapted to optimum absorption wavelength ranges of different organic components in the aerosol generating article 1000. When the base is applied to the first heating element 32 and/or the second heating element 33 that perform heating by radiating infrared rays, the base 31 is made of an infrared-transparent material, such as quartz, glass, and ceramic.

In still some embodiments, the first heating element 32 and/or the second heating element 33 are resistive heat layers. The first heating element 32 and/or the second heating element 33 may generate heat through resistance Joule heat to heat the aerosol generating article 1000 by directing a current on the first heating element 32 and/or the second heating element 33. In addition, in some embodiments, the first heating element 32 and/or the second heating element 33 used for heating by generating the resistive Joule heat may include nichrome, ferronickel, platinum, tungsten, silver, conductive ceramics, and the like. Alternatively, in still other optional embodiments, the resistive first heating element 32 and/or second heating element 33 may also be a resistive heating mesh, a resistive heating tube, or the like wound or coupled on the base 31.

Therefore, when the base is applied to the first heating element 32 and/or the second heating element 33 used for heating by resistance heating, the material of the base 31 is made of a material with a good thermal conductivity, such as ceramics, glass, and metal or alloy with surface insulation, such as anodized aluminum, aluminum alloy, copper alloy, stainless steel, or the like. Further, in some embodiments, a thermal conductivity of the base 31 is at least 10 W/m·k, preferably at least 100 W/m·k. Alternatively, in some embodiments, the thermal conductivity of the base 31 is greater than 200 W/m·k or higher. In some embodiments, the base 31 includes a metal suitable for the foregoing high thermal conductivity, such as aluminum, copper, titanium, or an alloy containing at least one of aluminum, copper, and titanium.

Further, in some embodiments, thicknesses of the first heating element 32 and/or the second heating element 33 may preferably be controlled in a range of 10 μm-300 μm. In addition, the first heating element 32 and/or the second heating element 33 may be formed on a surface of the tube-like base 31 by spraying on the outer surface of the tubular base 31 through atmospheric plasma spraying and then curing.

In some embodiments, the first heating element 32 and the second heating element 33 are sequentially arranged at intervals. In addition, the first heating element 32 and/or the second heating element 33 are substantially in an annular shape surrounding the base 31. The first heating element 32 and/or the second heating element 33 are closed in a circumferential direction.

In some specific embodiments, the base 31 has a wall thickness that is in a range of about 0.05-1 mm. The base 31 has an inner diameter that is in a range of about 5.0-8.0 mm. The base 31 has a length that is in a range of about 30-60 mm.

In some embodiments, the first heating element 32 and/or the second heating element 33 are coatings or thin layers formed on the base 31 through depositing or spraying. Alternatively, in still some embodiments, the first heating element 32 and/or the second heating element 33 are thin films wrapping or coupled on the base 31.

In some embodiments, the first heating element 32 and the second heating element 33 have substantially a same length. For example, in a specific embodiment, length dimensions of the first heating element 32 and the second heating element 33 are in a range of 10-20 mm. For another example, in a specific embodiment, the length dimensions of the first heating element 32 and/or the second heating element 33 are 12 mm.

Alternatively, in still some variant embodiments, the first heating element 32 and/or the second heating element 33 have different lengths. Alternatively, in still some variant embodiments, the length of the first heating element 32 is smaller than the length of the second heating element 33. Alternatively, in still some embodiments, a heater 30 may include only two infrared emitting layers, namely, the first heating element 32 and the second heating element 33. Alternatively, in still some embodiments, the heater 30 further includes more heating layers, for example, four, five, six, or more heating layers are sequentially arranged at intervals along an axial direction of the base 31.

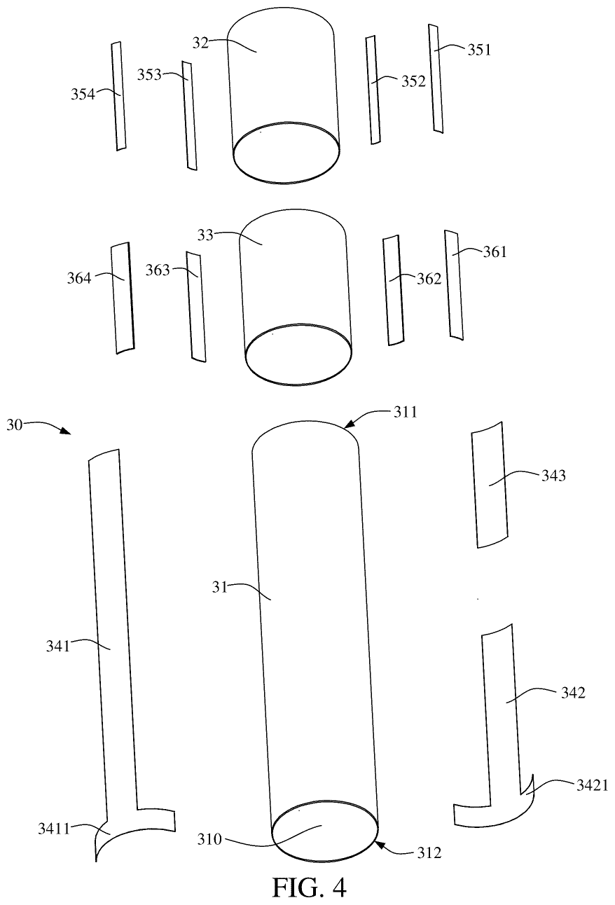

Further, FIG. 2 to FIG. 4 are schematic structural diagrams of a heater 30 according to an embodiment. In this embodiment, the heater 30 includes:
a first end 311 and a second end 312 facing away from each other along an axial direction. During implementation, two ends of the base 31 in a length direction respectively define the first end 311 and the second end 312 of the heater 30. An inner empty cavity 310 of the base 31 at least defines a chamber for receiving an aerosol generating article 1000.

In addition, the first heating element 32 and the second heating element 33 are formed on the base 31 and are sequentially arranged along a longitudinal direction of the base 31. Certainly, the first heating element 32 and the second heating element 33 are spaced.

Further, according to FIG. 2 to FIG. 4, the first heating element 32 is arranged close to the first end 311. The second heating element 33 is arranged close to the second end 312. In addition, the following are further defined on a surface of the base 31:
an exposed section 313, located between the first end 311 and the first heating element 32;
an exposed section 314, located between the first heating element 32 and the second heating element 33 to separate the first heating element 32 and the second heating element 33; and
an exposed section 315, located between the second heating element 33 and the second end 312.

In addition, in some embodiments, the exposed section 313 and the exposed section 314 have substantially the same dimensions along an axial direction of the base 31. For example, in some specific embodiments, the exposed section 313 and the exposed section 314 have lengths that are in a range of about 0.5-3 mm.

In addition, in some embodiments, the length of the exposed section 315 in the axial direction of the base 31 is greater than the length of the exposed section 313 and/or the length of the exposed section 314. For example, in some specific embodiments, the length of the exposed section 315 in the axial direction of the base 31 is in a range of 3-5 mm.

Further, as shown in FIG. 2 to FIG. 4, the heater 30 further includes:
a first electrode 341, being an electrode coating having an elongated or longitudinal shape, where the first electrode 341 extends from an end of the first heating element 32 close to the first end 311 to the exposed section 315, and a portion of the first electrode 341 is conductively connected to the first heating element 32, and an other portion of the first electrode 341 is also conductively connected to the second heating element 33. Alternatively, the first electrode 341 extends from the first heating element 32 to the second heating element 33. Alternatively, an extension length of the first electrode 341 crosses or substantially crosses the first heating element 32 and the second heating element 33. Alternatively, a length of the first electrode 341 is substantially equal to a sum of lengths of the first heating element 32, the exposed section 314, and the second heating element 33.

To facilitate connection of the first electrode 341 to the circuit board 140 through a conductive element or a soldering conductive lead, a circumferential extending portion 3411 is arranged at an end of the first electrode 341 located in the exposed section 315, so that the first electrode 341 has a T-shape. It is advantageous to form electrical conduction by connecting the circumferential extending portion 3411 to an electrically-conductive element or soldering an electrically-conductive lead. The T-shaped shape of the first electrode 341 and details for forming electrical conduction through assembling and fixing with a conductive element are provided by the applicant in Chinese Patent Application Publication No. CN215958354U, which is incorporated herein by reference in their entirety.

In addition, the heater 30 further includes:
a third electrode 342, being an electrode coating extending along a longitudinal direction of the heater 30, where the third electrode 342 extends from an end of the second heating element 33 close to the first end 311 to the exposed section 315. The third electrode 342 crosses the second heating element 33 and is in an electrically conductive connection with the second heating element 33. Moreover, the third electrode 342 is arranged facing away from the first electrode 341 along a radial direction of the base 31 or the heater 30. Moreover, an end of the third electrode 342 located at the exposed section 315 is provided with a circumferential extension 3421, so that the third electrode 342 has a T-shape, and the third electrode 342 is facilitated to be connected to the circuit board 140 after electrical conduction is formed by connecting the third electrode to a conductive element or soldering a conductive lead.

In addition, the heater 30 further includes:
a second electrode 343, being an electrode coating extending in the longitudinal direction of the heater 30, where the second electrode 343 is arranged facing away from the first electrode 341 along the radial direction of the base 31 or the heater 30. The second electrode 343 is substantially opposite to the fourth electrode 351 in the longitudinal direction of the base 31 or the heater 30. A length of the second electrode 343 along the axial direction of the heater 30 only covers the first heating element 32. The second electrode 343 is conductively connected to the first heating element 32.

Alternatively, in still some variant embodiments, the first electrode 341, the third electrode 342, and the second electrode 343 may be replaced with relatively thin sheet-shaped electrodes, and are formed on the heater 30 through soldering or attaching. The electrode is made of gold, silver, or copper with a low electrical resistance, or an alloy thereof.

Further, as shown in FIG. 2 to FIG. 4, the heater 30 further includes:
a fourth electrode 351, a fourth electrode 352, a fourth electrode 353, and a fourth electrode 354. These four electrodes are electrode coatings coupled on the first heating element 32, are sequentially arranged at intervals around the heater 30 and/or the first heating element 32 along a circumferential direction. Specifically, if an interface defined by a central axis of the first electrode 341 and the heater 30 is used as a boundary, the first heating element 32 has a first side and a second side separated through the interface. The fourth electrode 351 and the fourth electrode 352 are located on the first side and are arranged at intervals between the first electrode 341 and the second electrode 343. In addition, the fourth electrode 353 and the fourth electrode 354 are located on the second side, and are arranged at intervals between the first electrode 341 and the second electrode 343.

Further, as shown in FIG. 2 to FIG. 4, the heater 30 further includes:
a fifth electrode 361, a fifth electrode 362, a fifth electrode 363, and a fifth electrode 364. The four electrodes are electrode coating coupled on the second heating element 33 and are sequentially arranged at intervals around a circumferential direction of the heater 30 and/or the second heating element 33. Specifically, if an interface defined by a central axis of the first electrode 341 and the heater 30 is used as a boundary, the second heating element 33 has a first side and a second side that are separated through the interface. The fifth electrode 361 and the fifth electrode 362 are located on the first side and are arranged at intervals between the first electrode 341 and the third electrode 342. In addition, the fifth electrode 363 and the fifth electrode 364 are located on the second side and are arranged at intervals between the first electrode 341 and the third electrode 342.

In an embodiment, the fourth electrode 351, the fourth electrode 352, the fourth electrode 353, and the fourth electrode 354, and the fifth electrode 361, the fifth electrode 362, the fifth electrode 363, and the fifth electrode 364 are not directly connected to the circuit board 140, so that the electrodes are not used as voltage input to the circuit board 140. In other words, the fourth electrode 351, the fourth electrode 352, the fourth electrode 353, the fourth electrode 354, the fifth electrode 361, the fifth electrode 362, the fifth electrode 363, and the fifth electrode 364 are used as blank electrodes.

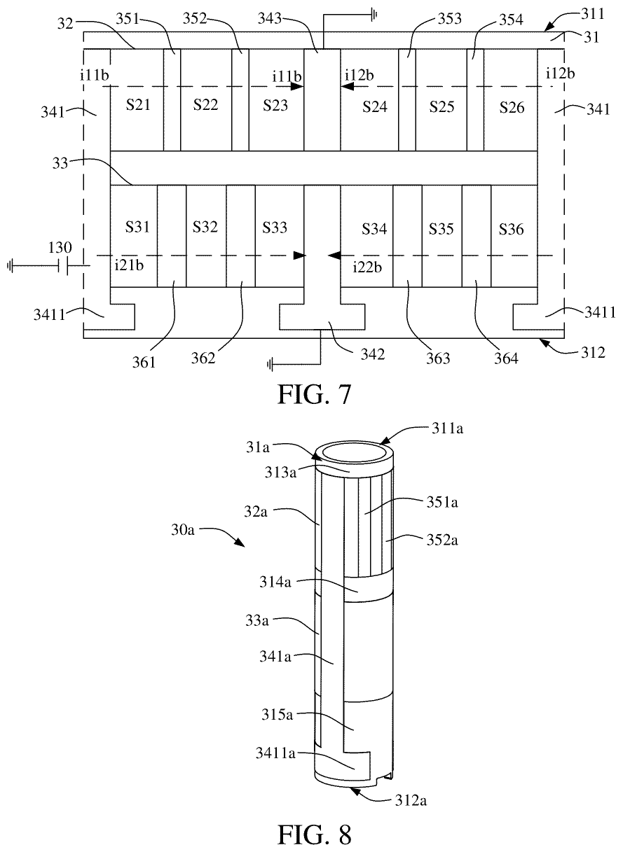

Through an arrangement of a blank electrode, a plurality of series-connected areas arranged at intervals along a circumferential direction are defined on the first heating element 32 and/or the second heating element 33. For example, as shown in FIG. 6 and FIG. 7, the first heating element 32 is divided to include:
an area S21, defined between the first electrode 341 and the fourth electrode 351;
an area S22, defined between the fourth electrode 351 and the fourth electrode 352, where the area S22 and the area S21 are connected in series through the fourth electrode 351;
an area S23, defined between the fourth electrode 352 and the second electrode 343, where the area S23 and the area S22 are connected in series through the fourth electrode 352;
an area S24, defined between the second electrode 343 and the fourth electrode 353;
an area S25, defined between the fourth electrode 353 and the fourth electrode 354, where the area S25 and the area S24 are connected in series through the fourth electrode 353; and
an area S26, defined between the fourth electrode 354 and the first electrode 341, where the area S26 and the area S25 are connected in series through the fourth electrode 354.

Similarly, the second heating element 33 is divided and includes:
an area S31, defined between the first electrode 341 and the fifth electrode 361;
an area S32, defined between the fifth electrode 361 and the fifth electrode 362; where the area S32 and the area S31 are connected in series through the fifth electrode 361;
an area S33, defined between the fifth electrode 362 and the third electrode 342 where the area S33 and the area S32 are connected in series through the fifth electrode 362;
an area S34, defined between the third electrode 342 and the fifth electrode 363;
an area S35, defined between the fifth electrode 363 and the fifth electrode 364; where the area S35 and the area S34 are connected in series through the fifth electrode 363; and
an area S36, defined between the fifth electrode 364 and the first electrode 341, where the area S36 and the area S35 are connected in series through the fifth electrode 364.

In use, any two or three of the first electrode 341, the third electrode 342, and the second electrode 343 can be selectively connected to the circuit board 140, so that a current is selectively directed on the first heating element 32 and/or the second heating element 33 of the heater 30. Specifically, for example, the first electrode 341, the third electrode 342, and the second electrode 343 are selectively connected to the circuit board 140 through a switch tube that may be switched between a turned-on state and a turned-off state, such as an MOS transistor, so that a section in which the heater 30 heats the aerosol generating article 1000 may be changed. For example, one of the first heating element 32 and the second heating element 33 may be enabled alone for heating and the other one is not enabled and not used for heating, so as to individually heat a part of sections of the aerosol generating article 1000. For another example, the first heating element 32 and the second heating element 33 are connected to the circuit board 140 in different in-series or in-parallel manners, so that the first heating element 32 and the second heating element 33 can simultaneously and separately heat different sections of the aerosol generating article 1000 to different temperatures at different powers, and sections of the aerosol generating article 1000 surrounded by the first heating element 32 and the second heating element 33 have different temperatures, thereby enabling different aerosol generating efficiency.

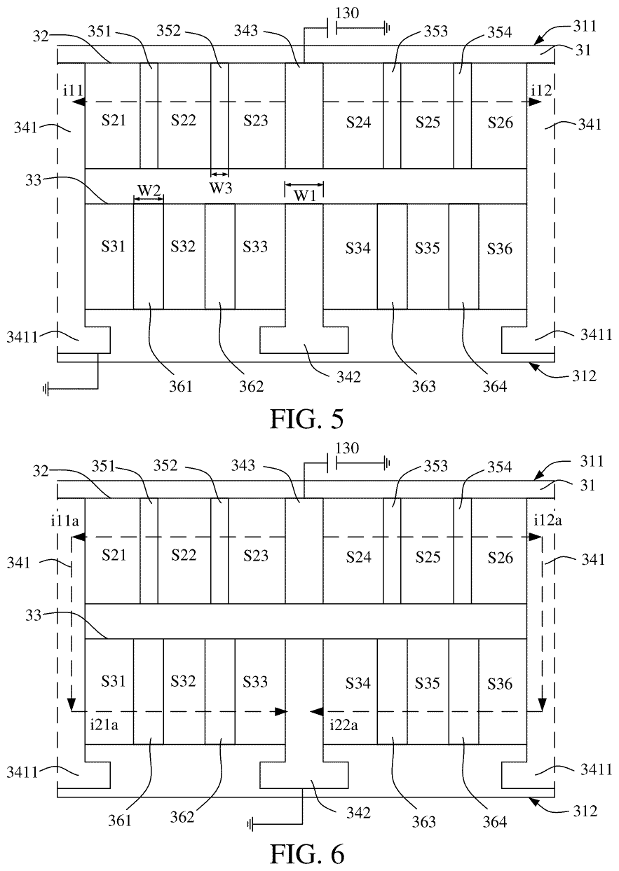

Specifically, for example, FIG. 5 is a schematic diagram of separately connecting a first electrode 341 and a second electrode 343 to a circuit board 140 according to an embodiment, so that the first electrode 341 and the second electrode 343 are correspondingly connected to a positive electrode and a negative electrode of the battery core 130 to form a circuit, thereby directing a current on the first heating element 32. As shown in FIG. 5, in a connection manner of forming a closed circuit in the manner in FIG. 5, an operating current is formed only on the first heating element 32 in a circumferential direction, and no current exists on the second heating element 33. The current on the first heating element 32 is divided into two paths. One current i11 flows from the second electrode 343 to the first electrode 341 sequentially through the area S23, the area S22, and the area S21 that are connected in series. The other current i12 flows from the second electrode 343 to the first electrode 341 sequentially through the area S24, the area S25, and the area S26 that are connected in series. For a connecting manner, the area S23, the area S22, and the area S21 that are connected in series are connected in parallel to the area S24, the area S25, and the area S26 that are connected in series.

Alternatively, based on a similar manner, after only the first electrode 341 and the third electrode 342 are respectively connected to the circuit board 140, the first electrode 341 and the third electrode 342 are respectively connected to the positive electrode and the negative electrode of the battery core 130 to form a circuit, so as to direct the current on the second heating element 33. Similarly, an operating current similar to that of the first heating element 32 in FIG. 5 is formed on the second heating element 33.

Further, FIG. 6 is a schematic diagram of directing a current to a first heating element 32 and a second heating element 33 by respectively connecting a third electrode 342 and a second electrode 343 to a circuit board 140 according to still another embodiment. According to FIG. 6, a current i11a and a current i12a that are from the second electrode 343 to the first electrode 341 are formed on the first heating element 32. In addition, a current i21a and a current i22a that are from the first electrode 341 to the third electrode 342 are formed on the second heating element 33.

In addition, in the connecting manner shown in FIG. 6, the current i21a and the current i22a are parallel, and the current i11a and the current i12a are parallel. In addition, the first heating element 32 and the second heating element 33 are connected in series through the first electrode 341, so as to simultaneously operate.

Further, FIG. 7 shows an electrical connection manner according to still another embodiment. A first electrode 341 is connected to a positive terminal of a battery core 130. A third electrode 342 and a second electrode 343 are both connected to a negative terminal of the battery core 130 through ground. In this case, in the embodiment shown in FIG. 7, the first heating element 32 and the second heating element 33 are connected in parallel, so as to simultaneously operate.

Obviously, a series resistance of the first heating element 32 and the second heating element 33 shown in FIG. 6 is larger than a parallel resistance of the first heating element 32 and the second heating element 33 shown in FIG. 7 as a whole. When power is provided through the battery core 130, the connection manner in FIG. 7 enables a power of simultaneously applying heat to the first heating element 32 and the second heating element 33 that simultaneously operate to be greater than a power for simultaneous heating in FIG. 6. Besides, obviously, in the connection manner in FIG. 7, different sections of an aerosol generating article 1000 may be relatively quickly heated.

Further, referring to FIG. 2 to FIG. 6, the first electrode 341, the second electrode 343, and the third electrode 342 used for connecting to the circuit board 140 have a width W1 along a circumferential direction of the heater 30. In addition, the fifth electrode 361, the fifth electrode 362, the fifth electrode 363, and the fifth electrode 364 that are used as blank electrodes on the second heating element 33 have a width W2 along the circumferential direction of the heater 30. In addition, a fourth electrode 351, a fourth electrode 352, a fourth electrode 353, and a fourth electrode 354 that are used as blank electrodes on the first heating element 32 have a width W3 along the circumferential direction of the heater 30. In addition, in this embodiment, the width W1 is greater than the width W2, and the width W2 is greater than the width W3. For example, in a specific embodiment, the base 31 has an outer diameter that is in a range of about 7.4-12.6 mm. In addition, a diameter of the first heating element 32 and a diameter of the second heating element 33 is based on the range of 7.4-12.6 mm. The width W1 is in a range of about 2-5 mm, the width W2 is in a range of about 1 mm to 4 mm, and the width W3 is in a range of about 0.5-3 mm.

Based on that the width W2 is greater than the width W3, a resistance value of the second heating element 33 is less than a resistance value of the first heating element 32 because a blank electrode covers a larger width of the second heating element 33. Further, when the first heating element 32 or the second heating element 33 is independently turned on for heating as shown in FIG. 5, or the first heating element 32 and the second heating element 33 in FIG. 7 are connected in parallel and heat are simultaneously applied, the operating power of the second heating element 33 is greater than the operating power of the first heating element 32. In addition, when the first heating element 32 and the second heating element 33 in FIG. 6 are connected in series and heat are simultaneously applied, the first heating element 32 has an operating power greater than that of the second heating element 33 because the first heating element has a larger resistance value.

Alternatively, in more variant embodiments, the first heating element 32 and/or the second heating element 33 have a larger quantity of blank electrodes. Alternatively, a quantity of blank electrodes on the first heating element 32 is different from that of blank electrodes on the second heating element 33, so that the first heating element 32 and the second heating element 33 can have different resistance values. For example, the quantity of the blank electrodes on the first heating element 32 is greater than that of the blank electrodes on the second heating element 33, so that the resistance value of the first heating element 32 is greater than the resistance value of the second heating element 33.

Alternatively, in still some variant embodiments, the heater 30 further includes:
a thermal insulation element, configured to surround or encase the first heating element 32 and/or the second heating element 33 from the outside to provide thermal insulation on the outside thereof. The thermal insulation element is, for example, a rolled-up aerogel blanket, a porous material, or a vacuum tube.

Alternatively, in still some variant embodiments, the thermal insulation element of the heater 30 is a tube having an inner thermal insulation cavity. A thermal insulation cavity is provided between an inner surface and an outer surface of a tubular thermal insulation element. A pressure of the thermal insulation cavity is lower than an outside pressure. In other words, the thermal insulation element is a vacuum thermal insulation tube with a vacuum degree. Alternatively, in still some variant embodiments, the thermal insulation cavity is provided between the inner outer surface and the outer surface of the tubular thermal insulation element. The thermal insulation cavity is filled with an insulating gas, such as argon. A thermal conductivity of argon gas is about one third less than that of air at the same pressure and temperature, effectively providing thermal insulation.

Alternatively, in still some variant embodiments, the heater 30 further includes:
a first temperature sensor, attached to a first heating element 32 to sense a temperature of the first heating element 32; and a second temperature sensor, attached to a second heating element 33 to sense a temperature of the second heating element 33.

Alternatively, in still some variant embodiments, the heater 30 further includes:
a thermoplastic close-fitting component, enclosing the first temperature sensor and/or the second temperature sensor outside the heater 30, so that the first temperature sensor and/or the second temperature sensor are closely attached to the outside of the heating layer.

In some embodiments, the thermoplastic close-fitting component includes at least one of a heat-resistant synthetic resin, polytetrafluoroethylene as Teflon, and silicon. In still some variant embodiments, the thermoplastic close-fitting component includes a heat shrink tube or a high-temperature-resistant tape.

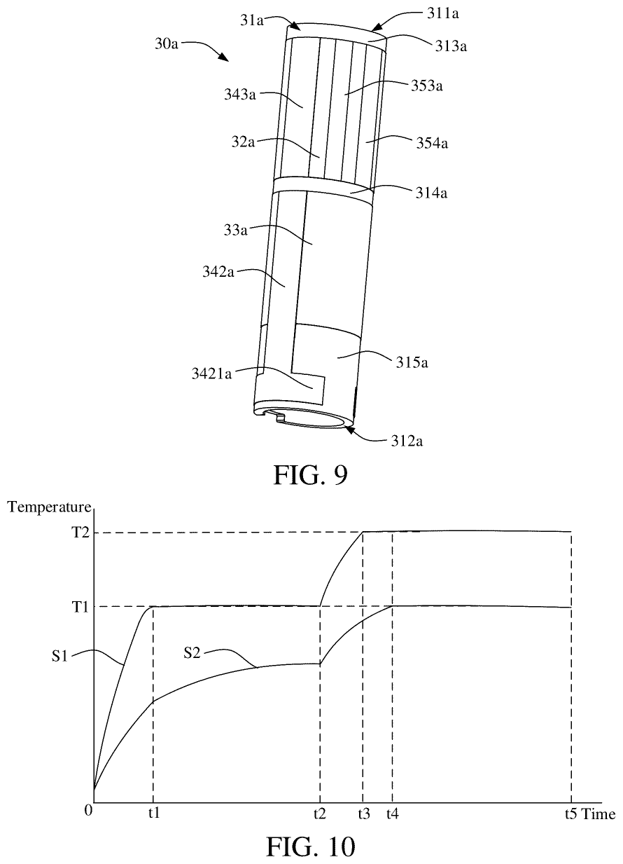

For another example, FIG. 8 and FIG. 9 are schematic diagrams of a heater 30 according to another embodiment. In this embodiment, the heater 30a includes:
a base 31a, having a first end 311a and a second end 312a opposite to each other; and
a first heating element 32a and a second heating element 33a, arranged on the base 31a at intervals along a longitudinal direction, where the first heating element 32a and/or the second heating element 33a may be infrared heat layers that perform heating through radiation of infrared light, or resistive heating layers that generate heat through resistive Joule heat. The first heating element 32a is close to the first end 311a. The second heating element 33a is close to the second end 312a.

In addition, the heater 30a further includes:
a first electrode 341a, a third electrode 342a, and a second electrode 343a, configured to be selectively connected to a circuit board 140, where the third electrode 342a is coupled to the second heating element 33a to form electrical conduction, the second electrode 343a is coupled to the first heating element 32a to form electrical conduction, the first electrode 341a extends from the first heating element 32a to the second heating element 33a, and the first electrode 341a is also in electrically conductive with the first heating element 32a and the second heating element 33a. In addition, the third electrode 342a and the second electrode 343a are aligned along a longitudinal direction. The first electrode 341a and the third electrode 342a are opposite to each other along a radial direction. The first electrode 341a and the second electrode 343a are opposite to each other along a radial direction.

Further, the first heating element 32a of the heater 30a is further thereon provided with:
a fourth electrode 351a, a fourth electrode 352a, a fourth electrode 353a, and a fourth electrode 354a, sequentially arranged at intervals around the circumferential direction of the first heating element 32a, where the first heating element 32a has a first side and a second side separated by a connecting surface of the first electrode 341a and the second electrode 343a, the fourth electrode 351a and a fourth electrode 352a are located on the first side and are arranged at intervals between the first electrode 341a and the second electrode 343a, and the fourth electrode 353a and the fourth electrode 354a are located on the second side and are arranged at intervals between the first electrode 341a and the second electrode 343a. In addition, in an embodiment, the circuit board 140 is not connected, so that the electrodes are not used as voltage input for the circuit board 140. The fourth electrode 351a, the fourth electrode 352a, the fourth electrode 353a, and the fourth electrode 354a are used as blank electrodes, and are configured only to reduce a resistance of the first heating element 32a and form in-series separation areas on the first heating element 32a.

In addition, in the heater 30a of this embodiment, the second heating element 33a is provided with no blank electrode. Further, during implementation, a resistance value of the first heating element 32a is smaller than that of the second heating element 33a. When the first heating element 32a and the second heating element 33a both perform heating in the electric connection manner shown in FIG. 6 or FIG. 7, the first heating element 32a can selectively perform heating at a power higher than or lower than that of the second heating element 33a.

In addition, in use, power can be selectively applied to the heater 30a in any one of the manners in FIG. 5 to FIG. 7, so that only one of the first heating element 32a and the second heating element 33a performs heating, or both of the first heating element and the second heating element perform heating.

For example, in a specific embodiment, a process to heat an aerosol generating article 1000 includes the following.

First stage S10: The first electrode 341a and the second electrode 343a are respectively connected to a positive electrode and a negative electrode of a battery core 130 in a manner shown in FIG. 5. In this stage, a current is directed only on the first heating element 32a, so that a first section of the aerosol generating article 1000 surrounded by the first heating element 32a is heated. Second stage S20: The third electrode 342a and the second electrode 343a are respectively connected to the positive electrode and the negative electrode of the battery core 130 in an electrical connection manner shown in FIG. 6, so that the first heating element 32a and the second heating element 33a are connected in series and simultaneously perform heating. It may be learned from a relationship formula P=I²×R between a power and a voltage and a resistance value that the first heating element 32a performs heating at a power lower than that of the second heating element 33a in the second stage due to the blank electrodes 351/352/353/354 on the first heating element 32a.

In this manner, in a preheating stage such as the first stage S10, the first section of the aerosol generating article 1000 surrounded by the first heating element 32a can be rapidly heated first. Then, in the second stage S20, the first section surrounded by the first heating element 32a and a second section surrounded by the second heating element 33a of the aerosol generating article 1000 are simultaneously heated, and a temperature of the second section of the aerosol generating article 1000 surrounded by the second heating element 33a gradually increases to be close to a temperature of the first section surrounded by the first heating element 32a, reducing a temperature difference thereof caused by only heating the first section in the first stage S10. Specifically, for example, in the first stage S10, the first heating element 32a is allowed to heat at a higher temperature than the second heating element 33a. In addition, in the first stage S10, the temperature of the first heating element 32a is higher than the temperature of the second heating element 33a, thereby having a first temperature difference. In addition, the first temperature difference may be constant or may vary, for example, gradually increase. In addition, in the second stage S20, the first temperature difference thereof due to the first heating element 32a is heated at a higher temperature in the first stage S10 is reduced, so that in the second stage S20, the temperature of the second heating element 33a gradually increases more quickly to be close to the temperature of the first heating element 32a, thereby gradually reducing the temperature difference thereof in the second stage S20. In other words, in the second stage S20, the temperature of the first heating element 32a is higher than the temperature of the second heating element 33a, thereby having a second temperature difference. The second temperature difference may also vary, for example, gradually decreases. In addition, the first temperature difference is greater than the second temperature difference. For example, in some embodiments, the first temperature difference is at least 100° C. and the second temperature difference is less than 50° C.

Alternatively, in still some embodiments, the first heating element 32 and the second heating element 33 are controlled and connected in parallel to the battery core 130 in the first stage, so that the first heating element and the second heating element simultaneously perform heating in parallel. The first heating element 32 and the second heating element 33 are controlled and connected in series to the battery core 130 in the second stage, so that the first heating element and the second heating element simultaneously perform heating in series.

For example, in a still changed embodiment, a process of heating the aerosol generating article 1000 includes the following.

First stage S10a: The first electrode 341a and the second electrode 343a are respectively connected to a positive electrode and a negative electrode of a battery core 130 in a manner shown in FIG. 5. In this stage, a current is directed only on the first heating element 32a, so that a first section of the aerosol generating article 1000 surrounded by the first heating element 32a is heated. Second stage S20a: The first electrode 341a, the third electrode 342a, and the second electrode 343a are respectively connected to the positive electrode and the negative electrode of the battery core 130 in an electrical connection manner shown in FIG. 7, so that the first heating element 32a and the second heating element 33a are connected in parallel and simultaneously perform heating. In the second stage, the first heating element 32a performs heating at a power higher than that of the second heating element 33a.

In the manner, in a preheating stage such as the first stage S10a, a first section of the aerosol generating article 1000 surrounded by the first heating element 32a can be rapidly heated first. Then, in the second stage S20a, the first section surrounded by the first heating element 32a and a second section surrounded by the second heating element 33a of the aerosol generating article 1000 are simultaneously heated, and the temperature of the first section of the aerosol generating article 1000 surrounded by the first heating element 32a gradually rises to a greater temperature difference with the temperature of the second section surrounded by the second heating element 33a.

For another example, in an embodiment, the electric connection manner shown in FIG. 7 is used all the time to cause the first heating element 32a and the second heating element 33a to simultaneously heat the first section and the second section of the aerosol generating article 1000. In a heating process, the first section and the second section of the aerosol generating article 1000 always have a different temperature. Specifically, reference may be made to FIG. 10 for a temperature curve of a heating process in which the electrical connection manner in FIG. 7 is used in this embodiment, and the temperature curve includes the following stages.

During a time period of 0-t1, a first heating element 32a is controlled to rapidly rise a temperature to a target temperature T1 for preheating. In addition, during the first time period, a temperature of a second section of the aerosol generating article 1000 rises more slowly than a first section and cannot rise equally rapidly to a temperature T1.

During a time period of t1-t2, a heating temperature of the first heating element 32a is controlled and substantially maintained at a target temperature T1 for heating, so that the surrounded first section of the aerosol generating article 1000 is heated to generate an aerosol. During the second time period, a heating temperature of the second heating element 33a substantially gradually increases, but a temperature is still lower than that of the first heating element 32a.

During a time period of t2-t4, the first heating element 32a is enabled to reach and maintain a higher temperature T2 at t3 that is earlier or faster than t4. Certainly, during the third time period, the second heating element 33a is subjected to a temperature rise, and has a temperature still lower than the temperature T2 of the first heating element 32a.

During a time period of t4-t5, the heating temperature of the first heating element 32a is controlled and maintained at the target temperature T2 for heating, until the inhalation ends.

In some specific implementations, the target temperature of the first heating element 32a during the time period of 0-t1 and the time period of t1-t2 is set to the temperature T1. The temperature T1 may be set to 200-450° C.

In addition, in the embodiment shown in FIG. 9, the target temperature of the second heating element 33a during the time period of t2-t4 and the time period of t4-t5 may also be set to the same temperature T1 as the target temperature of the first heating element 32a during the time period of 0-t1 and the time period of t1-t2.

Alternatively, in still some changed implementations, the target temperature of the second heating element 33a during the time period of t2-t4 and the time period of t4-t5 may be higher or lower than the target temperature of the first heating element 32a during the time period of 0-t1 and the time period of t1-t2.

In addition, in some specific implementations, a rapid heating and preheating time during a time period of 0-t1 may be set to about 5-20 s; the inhalation time during a time period of t1-t2 is about 40-80 s; a time period of t2-t4 is about 5-20 s; and the inhalation time during a time period of t4-t5 is about 40-100 s.

In addition, in the foregoing embodiments, during the time period of 0-t1 and the time period of t1-t2, the first heating element 32a is caused to rapidly heat the surrounded section of the aerosol generating article 1000 to rapidly generate the aerosol. Overall heat is further performed during the time period of t2-t4 and the time period of t4-t5.

Alternatively, in still some implementations, a length of the time period of t4-t5 may be greater than a length of the time period of t1-t2 to compensate for heating of the section of the aerosol generating article 1000 surrounded by the second heating element 33a.

In addition, in the foregoing implementations, the heating temperatures of the first heating element 32a and/or the second heating element 33a do not decrease. For example, the temperatures of the first heating element 32a and/or the second heating element 33a are increased stepwise.

It should be noted that the preferred embodiments of this application are provided in the specification and the accompanying drawings of this application, but are not limited to the embodiments described in this specification. Further, a person of ordinary skill in the art may make improvements or modifications according to the foregoing descriptions, and all of the improvements and modifications shall fall within the protection scope of the appended claims of this application.

1. An aerosol generating device, configured to heat an aerosol generating article to generate an aerosol, and comprising:
a chamber, configured to accommodate the aerosol generating article;
a first heating element and a second heating element, arranged along a longitudinal direction of the chamber and configured to heat the aerosol generating article; and
a battery core, configured to provide power to the first heating element and the second heating element, wherein
the aerosol generating device is configured to selectively electrically connect one of the first heating element and the second heating element to the battery core to separately perform heating, and selectively electrically connect the first heating element and the second heating element to the battery core in series or in parallel to simultaneously perform heating.

2. The aerosol generating device according to claim 1, comprising:
an opening, wherein in use, the aerosol generating article is at least partially accommodated in the chamber or removed from the chamber through the opening; and
the first heating element is closer to the opening than the second heating element.

3-4. (canceled)

5. The aerosol generating device according to claim 1, wherein when the first heating element and the second heating element are electrically connected to the battery core in series to simultaneously perform heating, an operating power of the first heating element is less than an operating power of the second heating element.

6. The aerosol generating device according to claim 1, wherein when the first heating element and the second heating element are electrically connected to the battery core in parallel to simultaneously perform heating, a power of the first heating element is greater than a power of the second heating element.

7. The aerosol generating device according to claim 1, configured to:
electrically connect the first heating element to the battery core separately during a first time period, so that the first heating element separately performs heating; and
electrically connect the first heating element and the second heating element in series to the battery core during a second time period, so that the first heating element and the second heating element simultaneously perform heating.

8. The aerosol generating device according to claim 1, configured to:
electrically connect the first heating element to the battery core separately during a first time period, so that the first heating element separately performs heating; and
electrically connect the first heating element and the second heating element in parallel to the battery core during a second time period, so that the first heating element and the second heating element simultaneously perform heating.

9. The aerosol generating device according to claim 1, configured to control power provided by the battery core to the first heating element and the second heating element, so that a temperature of the first heating element is higher than a temperature of the second heating element by a first temperature difference during a first time period, and the temperature of the first heating element is higher than the temperature of the second heating element by a second temperature difference during a second time period; and
the first temperature difference is greater than the second temperature difference.

10. The aerosol generating device according to claim 1, further comprising:
a first electrode, a second electrode, and a third electrode, selectively electrically connected to the battery core, wherein
the first heating element is at least partially electrically connected between the first electrode and the second electrode; and the second heating element is at least partially electrically connected between the first electrode and the third electrode.

11-12. (canceled)

13. The aerosol generating device according to claim 10, further comprising:
one or more fourth electrodes, arranged on the first heating element at intervals along a circumferential direction to reduce a resistance value of the first heating element, wherein the fourth electrodes are not electrically connected to the battery core.

14. The aerosol generating device according to claim 13, further comprising one or more fourth electrodes, arranged on the first heating element at intervals along the circumferential direction to separate the first heating element into at least two heating areas connected in series between the first electrode and the second electrode.

15. The aerosol generating device according to claim 13, wherein a width of the fourth electrode along a circumferential direction of the chamber is less than a width of the first electrode and/or the second electrode and/or the third electrode along the circumferential direction of the chamber.

16. The aerosol generating device according to claim 15, wherein the width of the fourth electrode along the circumferential direction of the chamber is in a range of 0.5-3 mm; and/or wherein the width of the first electrode and/or the second electrode and/or the third
electrode along the circumferential direction of the chamber is in a range of 2-5 mm.

17. (canceled)

18. The aerosol generating device according to claim 13, further comprising:
one or more fifth electrodes, arranged on the second heating element at intervals along the circumferential direction to reduce a resistance value of the second heating element, wherein the fifth electrodes are not electrically connected to the battery core.

19. The aerosol generating device according to claim 18, wherein a quantity of the fifth electrodes is different from a quantity of the fourth electrodes;
and/or a width of the fourth electrode along the circumferential direction of the chamber is different from a width of the fifth electrode along the circumferential direction of the chamber.

20. The aerosol generating device according to claim 10, further comprising:
one or more fifth electrodes, arranged on the second heating element at intervals along a circumferential direction to separate the second heating element into at least two heating areas connected in series between the first electrode and the third electrode.

21. The aerosol generating device according to claim 10, wherein the second electrode and the third electrode are aligned along the longitudinal direction of the chamber.

22. The aerosol generating device according to claim 10, wherein the first electrode and the second electrode are arranged opposite to each other along a radial direction of the chamber;
and/or the first electrode and the third electrode are arranged opposite to each other along the radial direction of the chamber.

23-24. (canceled)

25. The aerosol generating device according to claim 1, configured to:
electrically connect the first heating element and the second heating element in parallel to the battery core during a first time period, so that the first heating element and the second heating element simultaneously perform heating; and
electrically connect the first heating element and the second heating element in series to the battery core during a second time period, so that the first heating element and the second heating element simultaneously perform heating.

26-33. (canceled)

34. A heater for an aerosol generating device, comprising:
a first heating element and a second heating element arranged in sequence along a longitudinal direction; and
a first electrode, a second electrode, and a third electrode, wherein the first heating element is at least partially electrically connected between the first electrode and the second electrode, so as to supply power to the first heating element through the first electrode and the second electrode; and the second heating element is at least partially electrically connected between the first electrode and the third electrode, so as to supply power to the second heating element through the first electrode and the third electrode.

35-36. (canceled)

37. A control method for an aerosol generating device, the aerosol generating device comprising:
a chamber, configured to accommodate an aerosol generating article;
a first heating element and a second heating element, arranged along a longitudinal direction of the chamber and configured to heat the aerosol generating article; and
a battery core, configured to provide power to the first heating element and the second heating element; and
the method comprising:
controlling the battery core to separately provide the power to the first heating element during a first time period, so that the first heating element separately performs heating; and
control the battery core to simultaneously provide the power to the first heating element and the second heating element during a second time period, so that the first heating element and the second heating element simultaneously perform heating.

38-39. (canceled)
